(19) United States
(12) Patent Application Publication
(10) Pub. No.: US 2026/0015439 A1
(43) Pub. Date: Jan. 15, 2026

(54) PURGED POLYMER, PROCESS AND APPARATUS FOR PRODUCTION THEREOF

(71) Applicant: ExxonMobil Chemical Patents Inc., Baytown, TX (US)

(72) Inventor: Blu E. ENGLEHORN, Houston, TX (US)

(73) Assignee: ExxonMobil Chemical Patents Inc., Baytown, TX (US)

(21) Appl. No.: 18/992,864

(22) PCT Filed: Jul. 13, 2023
(86) PCT No.: PCT/US2023/027625

§ 371 Date: Jan. 9, 2025

Related U.S. Application Data
(60) Provisional application No. 63/392,040, filed on Jul. 25, 2022.

(51) Int. Cl. C08F 6/00; B01D 3/34; B01D 3/38; B01J 19/00

(52) U.S. Cl. CPC C08F 6/005; B01D 3/346; B01D 3/38; B01J 19/0013; B01J 2219/0015

(57) ABSTRACT

The present disclosure relates to a process for producing a polymer, in particular a purged polymer, including manufacturing a polymer in a polymerization reactor in the presence of a catalyst at a first temperature, wherein the catalyst has a maximum catalyst capability dependent on temperature, and wherein the polymer has a tackiness limit dependent on temperature; discharging the polymer from the polymerization reactor into a first process vessel; at least partially removing undesirable compounds including volatile organic compounds and/or residual polymerization reactants from the polymer and/or odorous compounds, and optionally contacting the polymer with a flow of purge gas in the first process vessel; transferring the polymer from the first process vessel to a second process vessel; contacting the polymer in the second process vessel with a flow of purge gas; and recovering a polymer product comprising the polymer from which undesirable compounds have been purged.

### FIELD OF INVENTION

The present disclosure relates to processes and systems to produce polymer compounds purged from volatile organic compounds (VOCs), and the polymers obtained therefrom.

### BACKGROUND

Polymers including polyolefin resins (for example, polyethylene or polypropylene) may be manufactured according to various catalytic processes, including liquid phase and gas phase processes. In such processes, the polymer product discharged from the reaction zone comprises solid polymer granules and volatile non-polymer components, e.g., monomer, comonomer, diluent and catalyst. These volatiles may be dissolved in, bound to, or otherwise attached to the polymer granules and/or in the vapor space external to the polymer granules. Heavy olefin monomers often used as comonomers in polyethylene polymerization processes, such as 1-hexene, are especially soluble in low density polyethylene. The process of removing these volatiles from the polymer product is referred to in the art as resin degassing or purging.

A polymer product may be purged by depressurizing the resin and stripping it with a light purge gas, such as nitrogen. In these processes, the polymer product is transferred to a lower pressure purge bin. The polymer product enters the upper portion of the vessel and is subjected to purge gas entering the vessel through ports or openings at the bottom of the vessel and possibly along the sides and other areas. It sweeps through the granular resin and exits the purge bin. The purged polymer product is discharged and conveyed to further downstream processes. A purge gas vent stream comprising the purge gas and purged volatiles, in particular volatile organic compounds (VOCs), is generally subjected to downstream processing in a recovery system to recover the VOCs, which may be recycled to the reactor, after which the remainder of the vent stream is flared. Background references for polymer purge and recovery systems include U.S. Pat. Nos. 3,797,707; 4,286,883; 4,372,758, 4,731,438, 4,758,654, 5,292,863, 5,462,351, 7,957,947, and 8,470,082; EP 2 172 494 A; WO2018/204026; and R. W. Baker and M. Jacobs, “Improve Monomer Recovery from Polyolefin Resin Degassing,” Hydrocarbon Processing, March 1996.

Optimizing the recovery of VOCs from the purged polymer product is challenging in view of operating equipment and VOC content constraints. For environmental and safety reasons, VOCs must be removed or reduced to an appropriate level in both the polymer product and flare gas before being exposed to the atmosphere. Additionally, it is economically advantageous to recover as much of the VOCs as possible to minimize the use of additional raw materials as well as compression and pumping energy.

Attempts have been made to manage the VOC content in polyolefins through improved purging methods and systems. For instance, U.S. Pat. Nos. 7,957,947; 8,249,748; and 8,543,242 relate to techniques for reducing VOC content in polyolefin by constructing and implementing a purge model column to calculate or estimate the VOC content in the polyolefin exiting the purge column. U.S. Pat. No. 10,035,864 relates to control methods and systems for purging a polymer product of volatiles, particularly a polymer product comprising polyethylene produced in a fluidized bed reactor.

Other references related to post-treatment of polymers include U.S. Pat. Nos. 8,344,099, 7,786,254, and 9,216,548; WO2008/080782; CN109694421; CN109575171; CN103124747; CN102453160; CN102827450; CN101987900; CN105085723; CN108466383; CN101613426.

Odor and VOC remaining in a polymer of any sort, and specifically polyolefins, are an ever-increasing focus area in polymers production. Traditional design of processes for production of polyolefins have typically focused only on removal of light VOCs (6-carbon molecules and lighter), primarily for safety reasons in production and/or delivery of the product. New designs of production plants and processes are required to reduce odor and VOC in these products to new, lower levels desired by the consumers in these markets, especially in automotive, nonwoven materials and household appliance markets. Since typical installations in the industry utilize external sources of heat to drive devolatilization of polymers, it is also necessary to minimize the amount of energy utilized during polymer production to achieve these ends.

### SUMMARY OF INVENTION

The present disclosure relates to processes and systems to produce polymer compounds purged from VOCs, and the polymers obtained therefrom.

A nonlimiting process of the present disclosure for producing a polymer, in particular a purged polymer, comprises the steps of: i) manufacturing a polymer in a polymerization reactor in the presence of a catalyst at a first temperature (T₁), wherein the catalyst has a maximum catalyst capability dependent on temperature, and wherein the polymer has a tackiness limit dependent on temperature; ii) discharging the polymer from the polymerization reactor into a first process vessel; iii) at least partially removing undesirable compounds including volatile organic compounds and/or residual polymerization reactants from the polymer and/or odorous compounds, and optionally contacting the polymer with a flow of a first purge gas in the first process vessel; iv) transferring the polymer from the first process vessel to a second process vessel; v) contacting the polymer in the second process vessel with a flow of a second purge gas; and vi) recovering a polymer product comprising the polymer from which undesirable compounds have been purged; wherein the first temperature is allowed to rise to the maximum of the catalyst capability and/or the tackiness limit of the polymer to prevent plugging and fouling; and wherein the steps ii) to v) are operated while maintaining the polymer at a second temperature (T₂) such that T₁−20° C.≤T₂≤T₁ and/or 70° C.≤T₂≤T₁, wherein the T₂ for the step ii) may be different than the T₂ for the step v).

A nonlimiting system of the present disclosure for producing a purged polymer comprises: a polymerization reactor suitable for being operated at a first temperature and for producing a polymer; a first process vessel configured for at least partially removing undesirable compounds including volatile organic compounds and/or residual polymerization reactants and/or odorous compounds from the polymer, the first process vessel comprising a first polymer inlet fluidically connected to the polymerization reactor for receiving the polymer, a first polymer outlet for discharging the polymer with a reduced content of undesirable compounds, a first exhaust gas outlet for evacuating at least some of the undesirable compounds, and optionally a first purge gas inlet for introducing a first purge gas; a second process vessel configured for purging the polymer with a reduced content of undesirable compounds, comprising a second polymer inlet fluidically connected to the first process vessel for receiving the polymer with a reduced content of undesirable compounds, a second polymer outlet for discharging the polymer purged from undesirable compounds, a second purge gas inlet for introducing a second purge gas and a second exhaust gas outlet for discharging the second purge gas charged with undesirable compounds purged from the polymer; a purge gas system configured to introduce the second purge gas in the second process vessel; a purged polymer recovery section fluidically connected to the second process vessel; wherein the system is configured for maintaining the polymer at a second temperature (T₂) while the polymer is flowing from the polymerization reactor to the second process vessel, such that T₁−20° C.≤T₂≤T₁ and/or 70° C.≤T₂≤T₁.

A nonlimiting process of the present disclosure for producing a polymer, in particular a purged polymer, comprises the steps of: i) manufacturing a polymer in a polymerization reactor in the presence of a catalyst; ii) discharging the polymer from the polymerization reactor into a first process vessel; iii) at least partially removing undesirable compounds including volatile organic compounds and/or residual polymerization reactants from the polymer and/or odorous compounds, and optionally contacting the polymer with a flow of a first purge gas in the first process vessel; iv) transferring the polymer from the first process vessel to a second process vessel; v) contacting the polymer in the second process vessel with a flow of a first purge gas; and vi) recovering a polymer from which undesirable compounds have been purged; wherein the step iii) comprises flowing the polymer in a plug-flow fashion into the first process vessel and feeding superheated steam in a countercurrent fashion to the polymer.

These and other features and attributes of the disclosed processes and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a schematic view of a first nonlimiting embodiment of a system that can be used in a purged polymer production process according to the present disclosure.

FIG. 2 illustrates a schematic view of a second nonlimiting embodiment of a system that can be used in a purged polymer production process according to the present disclosure.

FIG. 3 illustrates a schematic view of a third nonlimiting embodiment of a system that can be used in a purged polymer production process according to the present disclosure.

FIG. 4 illustrates a schematic view of a fourth nonlimiting embodiment of a system that can be used in a purged polymer production process according to the present disclosure.

FIG. 5 illustrates a schematic view of a fifth nonlimiting embodiment of a system that can be used in a purged polymer production process according to the present disclosure.

### DETAILED DESCRIPTION

The present disclosure relates to processes and systems to produce polymer compounds purged from VOCs, and the polymers obtained therefrom.

The following definitions are made for purposes of this disclosure and the claims thereto.

The term “polymer” according to the IUPAC refers to a substance composed of macromolecules. A macromolecule is a molecule of high relative molecular mass, the structure of which essentially comprises the multiple repetition of units derived, actually or conceptually, from molecules of low relative molecular mass.

When a polymer or oligomer is referred to as comprising an olefin, the olefin present in the polymer or oligomer is the polymerized or oligomerized form of the olefin, respectively. The term polymer is meant to encompass homopolymers and copolymers. The term copolymer includes any polymer having two or more different monomers in the same chain, and encompasses random copolymers, statistical copolymers, interpolymers, and (true) block copolymers.

When a polymer blend is said to comprise a certain percentage of a monomer, that percentage of monomer is based on the total amount of monomer units in all the polymer components of the blend. For example if a blend comprises 50 wt % of a polymer A which has 20 wt % monomer X, and 50 wt % of a polymer B which has 10 wt % monomer X, the blend of polymers A and B comprises 15 wt % monomer X. The blend components may be miscible, resulting in a single homogeneous phase, or immiscible, resulting in the presence of two or more morphological phases where each phase comprises a different ratio of the polymers.

A “polyolefin” is a polymer comprising at least 50 mol % of one or more olefin monomers. Preferably, a polyolefin comprises at least 60 mol %, or at least 70 mol %, or at least 80 mol %, or at least 90 mol %, or at least 95 mol %, or 100 mol % of one or more olefin monomers. Preferably the olefin monomers are selected from C2 to C20 olefins, or C2 to C16 olefins, or C2 to C10 olefins. More preferably the olefin monomers are selected from ethylene, propylene, 1-butene, 1-hexene, and 1-octene. Polyolefins may also comprise up to 50 mol % of one or more diene monomers.

The term “polyethylene” means a polymer or copolymer comprising at least 50 mol % ethylene units (preferably at least 70 mol % ethylene units, more preferably at least 80 mol % ethylene units, even more preferably at least 90 mol % ethylene units, even more preferably at least 95 mol % ethylene units or 100 mol % ethylene units (in the case of a homopolymer)).

The term “polypropylene” means a polymer made of at least 50 mol % (preferably at least 60 mol %, more preferably at least 70 mol %, more preferably at least 80 mol %, even more preferably at least 90 mol %, even more preferably at least 95 mol % or 100 mol %) propylene units and having less than 20 wt % ethylene units.

The term “impact copolymer” refers to two or more polymers in which one polymer may be dispersed in the other polymer, typically one polymer comprising a matrix phase and the other polymer comprising an elastomer phase. The matrix polymer may be a crystalline polymer, e.g., polypropylene homopolymer or polypropylene copolymer, and the polymer comprising the elastomer phase may be a rubber or elastomer. The polymer that forms the elastomer phase can comprise between about 5 and about 50, between about 10 and 45 and between about 10 and 40 wt % of the impact polymer. Exemplary impact copolymers can include blends of propylene homopolymer and propylene/ethylene copolymer (i.e., a poly(propylene-co-propylene/ethylene impact copolymer). Impact copolymers can be produced by mechanical blending or through the use of multi-stage reactors. Usually impact copolymers are formed in a dual or multi-stage process.

The manner in which the ICPs are produced is not critical to the present disclosure. They can be produced by conventional melt blending of the individual components, by “reactor blending” (“reactor produced”), by combinations of these two processes, or other means which achieves a dispersion of discrete elastomer regions within a substantially continuous polypropylene matrix. By “reactor blending,” it is meant that the polypropylene and rubber components are produced in situ during a single or multiple stage polymerization process. The rubber phase exists in discrete domains dispersed throughout the polypropylene phase. Most commonly, the rubber will be an ethylene-propylene rubber or an ethylene-propylene terpolymer rubber, however, other rubber compositions may be used. The term “rubber,” as used in this description and the appended claims shall mean any essentially non-crystalline polymeric component having a low glass transition temperature (typically ≤−35° C.), typically a copolymer of propylene derived units and at least one other monomer derived unit selected from ethylene and at least one C4 to C10 α-olefin.

The ICP may be made using any appropriate polymerization process. In one embodiment, the process includes the use of a metallocene catalyst system. Such systems are well known in the art, and are able to produce ICPs having certain desirable characteristics.

In one desirable embodiment, the metallocene produced impact copolymer is reactor produced, wherein the “polypropylene component” of the copolymer is produced in one stage, and the “rubber component” is produced in another stage in the presence of the polypropylene component.

In another embodiment, the polymerization process to make ICPs includes the use of a Ziegler-Natta catalyst system. Examples of suitable catalyst systems and methods of production are found in U.S. Pat. Nos. 6,087,459, 5,948,839, 4,245,062, and 4,087,485. Examples of catalyst systems useful in the formation of the impact copolymer are Ziegler-Natta catalyst systems described in U.S. Pat. Nos. 4,990,479, 5,159,021 and 6,111,039.

As used herein, an “olefin/polyolefin separation” step, apparatus, means or stage refers to any process or means of separating unreacted olefin monomer from polyolefin that has formed, for example, from a polymerization medium, such as by physical separation and/or separation by heating and/or pressure changes to the mixture, and as used herein preferably refers to the separation of propylene from forming polypropylene, ethylene-propylene copolymer and/or the impact copolymer.

As used herein the term “polymerization reactor” encompasses any type of reactor such as but not limited to stirred tank reactor, loop reactor, fluidized bed reactor, tubular reactor, tower reactor or extruder reactor. It is preferred that the polymerization reactor system be a gas phase polymerization reactor system.

The term “volatile” as used herein refers to a component or compound that has a low relative boiling point compared with the components or compounds around it.

The term “volatile organic compound” or “VOC” as used herein refers to a volatile C1-C16 hydrocarbon. VOCs can be saturated or unsaturated, inert or non-inert, can have a boiling point of less than 260° C., can have a saturated vapor pressure of 133.32 Pa or more at room temperature (23±2° C.) and can be present in the air in their vapor phase at normal temperature (25±2° C.). The C1-C16 hydrocarbon can also contain any elements selected from halogens, oxygen, sulfur, phosphorus, silica or nitrogen. Other compounds causing odors such as non-organic containing sulfur or nitrogen compounds can be considered as VOC. As used herein, VOC does not include carbon oxides (CO and CO2), inorganic carbonates or bicarbonates. VOC includes odorous or non-odorous organic compounds.

The term “C6-C16 volatile organic compounds” shall mean VOCs containing 6-16 carbon atoms, including but not limited to, benzene, toluene, ethylbenzene, xylene, and styrene.

The term “C1-C16 volatile organic compounds” shall mean VOCs containing 1-16 carbon atoms, including but not limited to, benzene, toluene, ethylbenzene, xylene, styrene, formaldehyde, acetaldehyde, and acrolein.

The term “odorous compounds” as used herein refers to molecules or substances olfactively perceptible by humans. Those compounds vaporize by evaporation or sublimation under ambient temperatures. Such compounds may be organic or not and may have a molecular mass lower than 300. Not all volatile compounds have an odor. Non-limitative examples of such odorous compounds include acetaldehyde, allyl mercaptans, ammonia, amyl mercaptans, benzyl mercaptan, butylamine, cadaverine, chlorine, chlorophenol, crotyl mercaptan, dibutylamine, diisopropylamine, dimethyl sulfide, diphenyl sulfide, ethylamine, ethyl mercaptan, hydrogen sulfide, indole, methylamine, methyl mercaptan, putrescine, pyridine, skatole, sulfur dioxide, tert-butyl, thiophenol, triethylamine, some hydrocarbons, some aromatics, some esters and some ketones, among others.

The term “undesirable compounds” in the context of the present disclosure includes at least one of the volatile organic compounds, odorous compounds and residual polymerization reactants.

The term “purge” as used herein refers to the process of removing unwanted dissolved and undissolved gases, including VOCs and/or other volatile compounds, from a solid granular polymer resin that has interstitial space filled with gas. In addition to the interstitial gas, volatile compounds, e.g., VOCs, may be dissolved in the resin. The purging operation consists of creating a sufficient driving force to cause the absorbed volatile compound to diffuse from the resin.

The term “purged polymer” or “degassed polymer” as used herein refers to a polymer which has been treated by a purging operation to remove partially or totally volatile compounds and odorous compounds from the polymer.

The term “purge gas” as used herein refers to any gas suitable for purging a polymer, such as an inert gas including nitrogen or argon or small hydrocarbon molecules such as methane, ethane, ethylene, propane, or propylene. The purge gas may also comprise a percentage of moisture or steam.

The term “superheated steam” as used herein refers to steam heated to a temperature higher than its vaporization point at the absolute pressure where the temperature is measured.

The term “plug flow” as used herein refers to a model of the velocity profile of a fluid flowing through a pipe or process vessel having a substantially constant cross section, wherein the velocity of the fluid is assumed to be constant across any cross-section of the pipe or process vessel perpendicular to the axis of the pipe or process vessel.

The term “heat exchanger” refers to a device designed to efficiently transfer or “exchange” heat from one matter to another. Exemplary heat exchanger types include a co-current or countercurrent heat exchanger, indirect heat exchanger (e.g. spiral wound heat exchanger, plate-fin heat exchanger such as a brazed aluminum plate fin type, shell-and-tube heat exchanger, etc.), direct contact heat exchanger, or some combination of these, a shell-and-tube heat exchanger, spiral, U-shaped, honeycomb, boiler-cell, lamellar with etched channels, such as a pipe in a pipe or related to any other known type of heat exchangers. The term heat exchanger in the broad sense means any device suitable for transferring thermal energy or cold from one medium to another medium, for example, between at least two different fluids. The term heat exchanger may also refer to any column, column apparatus, unit, or other arrangement providing for the passage of one or more flows through it and providing direct or indirect heat exchange between one or more refrigerant lines and one or more source streams.

The term “insulated” or “insulating” means either (1) the inclusion of a separate thermal insulating material on or within an item or (2) an item constructed such that in operation it will act as a thermal insulating material. A thermal insulating material is defined as a material with a thermal conductivity of less than 12 Watts/m-° C. (7 Btu/hr-ft-° F.). Exemplary insulating materials include mineral fibers (such as perlite), rubber, plastic foams (e.g. polyurethane foams, polyvinyl chloride foams, polystyrene foams), glass fibers, a vacuum, and/or microporous insulation such as aerogel. The term item used above is meant to refer to any physical item. Exemplary items include pipes, fluid conduits, purge vessels. Exemplary insulated items include a pipe-in-pipe construction with any of the above mentioned insulating materials in the annulus between the pipes, a hose made in part of stainless steel wire, polymeric films and polymeric fabrics, polyurethane foam and rubber, a composite pipe made of stainless steel bellows, polypropylene armors, insulation and rubber.

The term “connected” used herein means that a first element may be directly connected to a second element or indirectly connected to a second element through one or more intervening elements.

For ease of description, the present disclosure will be described herein with reference to a gas-phase propylene polymerization process, although it will be immediately apparent that the principles on which the present disclosure is based can be applied to any other exothermic polymerization process in which the polymer recovered after polymerization contains VOCs that need to be purged from the polymer. The present disclosure is suitable for the production and purge of any kind of polymers such as but not limited to homopolymers, copolymers, polyolefins, polyethylene, polypropylene, impact copolymers, polystyrenes, polyesters, polyurethane, polysiloxanes, polyacrylates, etc.

In a first aspect, the present disclosure is related to a process for producing a polymer, in particular a purged polymer, comprising the steps of:
i) manufacturing a polymer in a polymerization reactor in the presence of a catalyst at a first temperature (T₁) (also referred to herein as “reaction temperature” or “reactor temperature”), wherein the catalyst has a maximum catalyst capability dependent on temperature, and wherein the polymer has a tackiness limit dependent on temperature;
ii) discharging the polymer from the polymerization reactor into a first process vessel;
iii) at least partially removing undesirable compounds including volatile organic compounds and/or residual polymerization reactants from the polymer and/or odorous compounds from the polymer and optionally contacting the polymer with a flow of purge gas in the first process vessel;
iv) transferring the polymer from the first process vessel to a second process vessel;
v) contacting the polymer in the second process vessel with a flow of purge gas; and
vi) recovering a polymer from which undesirable compounds have been purged
wherein the T₁ is allowed to rise to the maximum of the catalyst capability and/or the tackiness limit of the polymer to prevent plugging and fouling, and steps ii) to v) are operated while maintaining the polymer at a second temperature (T₂) of (a) and/or (b), where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁ or 90° C.≤T₂≤T₁). Alternatively, the steps ii) to v) are operated while maintaining the polymer at a T₂ of T₁+30° C.≥T₂≥T₁ (or T₁+20° C.≥T₂≥T₁, or T₁+10° C.≥T₂≥T₁).

It has been observed that by increasing the reaction temperature in the reactor to the maximum of the catalyst capability and/or the tackiness limit of the polymer to prevent plugging and fouling and by maintaining the latent heat of the polymer throughout the following steps ii) to v), preferably with a combination of heated purge gas media and high insulation capacity of downstream vessels and piping, the odor characteristics of the polymer and the amount of VOC is significantly decreased.

The polymer may be manufactured according to any known polymerization process, including gas phase processes (for example those carried out in fluidized bed reactors or mechanically agitated bed reactors) and liquid phase processes (for example those carried out in autoclaves or tubular reactors).

Preferably, the polymer is manufactured in a polymerization process taking place in a gas-phase reactor, more preferably in a fluidized bed reactor.

In the process according to the disclosure, the manufacturing of the polymer is preferably operated in the gas-phase condition. The reaction temperature is allowed to rise to the maximum of the catalyst capability and/or the tackiness limit of the polymer to prevent plugging and fouling, whichever is lower. In the case of a polypropylene impact copolymer manufacturing process operating in the gas phase, the reaction temperature may be in the range of 70° C. to 110° C., with a preferred range of 90° C. to 100° C. The latent heat of the polymer achieved in this manner is then maintained throughout the following steps preferably with a combination of heated purge gas media and high insulation capacity of downstream vessels and piping. Alternatively, this heat can be introduced through a number of mechanical heating processes where steam, fired, or electrical heating mediums are used to heat the polymer in a vessel, either upstream of or within a purge vessel utilized in the purge process. The process according to the disclosure can be followed by polymer extrusion/pelletization.

The polymer can be maintained at second temperature (T₂) of (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁).
providing thermal insulation to at least one location between the polymerization reactor and the second process vessel; and/or
injecting hot steam or superheated steam in the first process vessel; and/or
heating the said purge gas.

Step iii) can be performed by:
allowing evaporation of at least some of the undesirable compounds from the polymer in the first process vessel and evacuating the at least some of the undesirable compounds; or
contacting the polymer with steam in the first process vessel and evacuating the steam charged with the at least some of the undesirable compounds from the first process vessel; or
contacting the polymer with a flow of purge gas in the first process vessel and evacuating the purge gas charged with the at least some of the undesirable compounds from the first process vessel; or
contacting the polymer with purge gas and steam in the first process vessel and evacuating a mixed stream charged with the at least some of the undesirable compounds, purge gas and steam from the first process vessel.

Step iii) can performed in the presence of steam, preferably hot steam or superheated steam, and can be followed by a step of drying prior to step v).

Step v) is preferably performed in the absence of steam in order to recover a dry and purged polymer in step vi).

In one embodiment, in the first process vessel, a relatively low flow of an inert gas is introduced. This gas may also be wetted to a point below its moisture saturation point via water or steam addition to the inert gas flow. Preferably, step iii) utilizes the latent heat of the polymer, prevented from significantly cooling via heated inert gas stream, to drive diffusion of any volatile and/or odorous molecules from the polymer into the gas stream which is then vented to a recovery or destruction system. Introduction of low quantities of moisture also allows remaining catalyst and/or co-catalyst species to be deactivated in this step. The relatively low flow rate of the inert gas allows the polymer to move in a plug-flow fashion in this step of the process to prevent bypass (shorter than normal residence time in the vessel that could otherwise be caused by fluidized or agitated flow systems) of material to the outlet of the vessel that may not be well-purged.

Preferably, in the second process vessel, a relatively high flow (i.e. higher than the flow in the first process vessel) of heated inert gas is introduced in order to (a) fluidize the flowing bed of polymer solids and, again, (b) prevent cooling of the polymer such that diffusion rates of the volatile and/or odorous molecules are maximized. The fluidized polymer solids bed is subjected to significantly higher surface renewal and inert gas flow such that devolatilization of the polymer is maximized.

The process according to the disclosure is adapted for the production and purge of any kind of polymers such as but not limited to homopolymers, copolymers, impact copolymers, polyolefins, polyethylene, polypropylene, polystyrenes, polyesters, polyurethane, polysiloxanes, polyacrylates, etc.

In a first embodiment of the process, a polymer is manufactured in a polymerization reactor, preferably in a gas phase polymerization reactor, at a first temperature (T₁), preferably at a temperature of at least 70° C. (or at least 80° C., or at least 90° C., or at most 95° C., or at most 100° C., or at most 110° C., or at most 120° C.). The polymer is then discharged to a first process vessel through a first transfer line. Undesirable compounds such as volatile organic compounds, odorous compounds and/or residual polymerization reactants are at least partially removed by evaporation under the latent heat of the polymer and evacuated though an exhaust gas outlet of the first process vessel, the exhaust gas outlet which can be connected to a recovery system, a waste recipient or a burner. A recovery system generally includes at least one recovery line and optionally a separation system such as a fractionation column or distillation column or purification column adapted to separate various constituents of exhaust gases, such that some of the constituents such as monomers of ethylene or propylene can be purified and reused in the reactor. A vacuum system or a pump may be provided to the exhaust gas outlet for facilitating the removal of undesirable compounds. The polymer is then transferred from the first process vessel to a second process vessel wherein the polymer is contacted with a flow of purge gas, preferably nitrogen, for completing the removal of undesirable components. Preferably, the purge gas is introduced in the second process vessel in a countercurrent fashion relative to the polymer which is introduced in the second process in a plug-flow fashion. The undesirable compounds and the purge gas are evacuated though an exhaust gas outlet of the second process vessel which can be connected to a second recovery system, a waste recipient or a burner. A vacuum system or pump may be connected to the exhaust gas outlet for facilitating the removal of VOCs and/or residual polymerization reactants and the purge gas. The polymer is maintained at a second temperature (T₂) of (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁) by (i) providing thermal insulation to at least one location between the polymerization reactor and the second process vessel and/or (ii) by heating the said purge gas. The polymer is thereby purged from undesirable compounds and can be used for further processing.

In a second embodiment of the process, a polymer is manufactured in a polymerization reactor, as mentioned above. The polymer is discharged to a first process vessel through a first transfer line. In the first process vessel, undesirable compounds are at least partially removed by contacting the polymer with a flow of purge gas, preferably hydrocarbon gas such as C1-C4 hydrocarbon gas, for example ethane, ethylene, propane or propylene. Undesirable compounds are evacuated from the first process vessel though an exhaust gas outlet of the first process vessel, the exhaust gas outlet which can be connected to a recovery system as mentioned above, a waste recipient or a burner. A pump or a vacuum system may be connected to the exhaust gas outlet for facilitating the removal of purge gas charged with at least some of the undesirable compounds. Preferably, the purge gas is introduced in the first process vessel in a countercurrent fashion relative to the polymer which is introduced in the first process vessel in a plug-flow fashion. The polymer is then transferred from the first process vessel to a second process vessel wherein the polymer is contacted with a flow of purge gas, preferably nitrogen, for completing the removal of undesirable compounds. Preferably, the purge gas is introduced in the second process vessel in a countercurrent fashion relative to the polymer which is introduced in the second process vessel in a plug-flow fashion. The undesirable compounds and the purge gas are evacuated though an exhaust gas outlet of the second process vessel which can be connected to a second recovery system, a waste recipient or a burner. A pump or a vacuum system may be connected to the second exhaust gas outlet for facilitating the removal of the undesirable compounds entrained by the purge gas. The polymer is maintained at a second temperature (T₂) of (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁) by (i) providing thermal insulation to at least one location between the polymerization reactor and the second process vessel and/or (ii) heating the said purge gas. The polymer thereby purged from undesirable compounds is recovered and can be used for further processing.

In a third embodiment of the process, a polymer is manufactured in a polymerization reactor, as mentioned above. The polymer is then discharged to a first process vessel through a first transfer line. In the first process vessel, undesirable compounds are at least partially removed by contacting the polymer with a flow of hot steam or superheated steam. At least some of the undesirable compounds and steam or moisture are evacuated from the first process vessel though an exhaust gas outlet of the first process vessel, the exhaust gas outlet which can be connected to a recovery system as already mentioned, a waste recipient or a burner. A pump or a vacuum system may be connected to the exhaust gas outlet for facilitating the removal of undesirable compounds and steam. Preferably, the steam is introduced in the first process vessel in a countercurrent fashion relative to the polymer which is introduced in the first process vessel in a plug-flow fashion. The polymer is then transferred from the first process vessel to a second process vessel wherein the polymer is contacted with a flow of purge gas, preferably nitrogen, for completing the removal of undesirable compounds. Preferably, the purge gas is introduced in the second process vessel in a countercurrent fashion relative to the polymer which is introduced in the second process in a plug-flow fashion. The undesirable compounds and the purge gas are evacuated though an exhaust gas outlet of the second process vessel which can be connected to a second recovery system, a waste recipient or a burner. A pump or a vacuum system may be connected to the exhaust gas outlet for facilitating the removal of undesirable compounds and the purge gas. The polymer is maintained at a second temperature (T₂) of (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁) by (i) providing thermal insulation to at least one location between the polymerization reactor and the second process vessel and/or (ii) heating the said purge gas. The polymer thereby purged from undesirable compounds is recovered and can be used for further processing.

In a fourth embodiment of the process, a polymer is manufactured in a polymerization reactor, as mentioned above. The polymer is then discharged to a first process vessel through a first transfer line. In the first process vessel, the undesirable compounds are at least partially removed by contacting the polymer with a flow of purge gas, preferably hydrocarbon gas, and a flow of hot steam. The flow of purge gas and the flow of hot steam may be provided simultaneously or separately. The undesirable compounds, the purge gas and the hot steam are evacuated though an exhaust gas outlet of the first process vessel, the exhaust gas outlet which can be connected to a recovery system as mentioned above, a waste recipient or a burner. A pump or a vacuum system may be connected to the exhaust gas outlet for facilitating the removal of the undesirable compounds, the purge gas and the steam. Preferably, the steam and the purge gas are introduced in the first process vessel in a countercurrent fashion relative to the polymer which is introduced in the first process vessel in a plug-flow fashion. The polymer is then transferred from the first process vessel to a second process vessel wherein the polymer is contacted with a flow of purge gas, preferably nitrogen, for completing the removal of undesirable compounds. Preferably, the purge gas is introduced in the second process vessel in a countercurrent fashion relative to the polymer which is introduced in the second process in a plug-flow fashion. The undesirable compounds and the purge gas are evacuated though an exhaust gas outlet of the second process vessel which can be connected to a second recovery system, a waste recipient or a burner. A pump or a vacuum system may be connected to the exhaust gas outlet for facilitating the removal of undesirable compounds and the purge gas. The polymer is maintained at a second temperature (T₂) of (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁) by (i) providing thermal insulation to at least one location between the polymerization reactor and the second process vessel and/or (ii) heating the said purge gas. The polymer thereby purged from undesirable compounds is recovered and can be used for further processing.

In a fifth embodiment of the process, the same steps as the third embodiment of the process are performed, but a further step of drying is performed after contacting the polymer with the steam and/or purge gas, and before transferring the polymer in the second process vessel. The step of drying is performed in the first process vessel, for example by heating and stirring the polymer, or preferably in a dryer arranged between the first process vessel and the second process vessel.

Any of the embodiments of the processes disclosed hereinabove may further comprise additional steps of purging in additional process vessels arranged between the first process vessel and the second process vessel. It is important that steam or moisture should not be introduced in the second process vessel in order to provide a dry and purged polymer that can be utilized for further processing. Hydrocarbon gas is preferably used as purge gas in the first process vessel, so that the exhaust gas exiting the first process vessel can be easily separated and unreacted monomers eventually present in the polymer can be easily recovered, purified and reused in the reactor. When steam is introduced in the first process vessel, the recovery system may include any membrane, absorption device or condensation system to recover the water. If a portion of the exhaust gas of the first process vessel is recovered and reused in the reactor, nitrogen is preferably not used as a purge gas in the first process vessel, to prevent catalyst deactivation in the reactor.

In any of the embodiments of the processes disclosed hereinabove, the flow rate of the purge gas in the second process vessel is preferably higher than the flow of purge gas provided in the first process vessel or any flow of purge gas provided in any of the process vessel upstream of the second process vessel.

Advantageously, in any one of the embodiments of the processes disclosed hereinabove, the purge gas is heated to a temperature sufficient to maintain the second temperature (T₂) at (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁). Preferably, the purge gas injected into the first purge vessel comes from a first purge gas source and the purge gas injected into the second purge vessel comes from a second purge gas source.

In a second aspect, the present disclosure is related to a system for producing a purged polymer, the system comprising:
a polymerization reactor suitable for being operated at a first temperature (T₁) and for producing a polymer;
a first process vessel configured for at least partially removing undesirable compounds including volatile organic compounds and/or residual polymerization reactants and/or odorous compounds from the polymer, comprising a first polymer inlet fluidically connected to the polymerization reactor for receiving the polymer, a first polymer outlet for discharging the polymer with a reduced content of undesirable compounds, a first exhaust gas outlet for evacuating at least some of the undesirable compounds, and optionally a purge gas inlet for introducing a purge gas;
a second process vessel configured for purging the polymer with a reduced content of undesirable compounds, comprising a second polymer inlet fluidically connected to the first process vessel for receiving the polymer with a reduced content of undesirable compounds, a second polymer outlet for discharging the polymer purged from undesirable compounds, a purge gas inlet for introducing a purge gas and a second exhaust gas outlet for discharging the purge gas charged with undesirable compounds purged from the polymer;
a first purge gas system configured to introduce a purge gas in the second process vessel;
a purged polymer recovery section fluidically connected to the second process vessel;
wherein the system is configured for maintaining the polymer at a second temperature (T₂) of (a) and/or (b) where (a) is T1−20° C.≤T2≤T1 (or T1−15° C.≤T2≤T1, or T1−10° C.≤T2≤T1, or T1−5° C.≤T2≤T1) and (b) is 70° C.≤T2≤T1 (or 80° C.≤T2≤T1, or 90° C.≤T2≤T1), while the polymer is flowing from the reactor to the second process vessel.

The reactor can be connected to a first process vessel by a first transfer line, the first process vessel can be connected to the second process vessel by a second transfer line, and the second process vessel can be connected to the purged polymer recovery section by a third transfer line.

In one embodiment or preferably, the system comprises a second purge gas system configured to introduce a purge gas in the first process vessel.

In order to maintain the polymer at a second temperature (T₂) of (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁), while the polymer is flowing from the reactor to the second process vessel, the system comprises at least one of the following:
An insulated portion of the system (not shown) arranged to at least one location between the polymerization reactor and the second process vessel;
A heater or a heat exchanger configured for heating the purge gas.

In one embodiment or preferably, the system comprises a steaming system configured to introduce hot steam or superheated steam in the first process vessel. Without being bounded by any theory, the hot steam may be allowed to deactivate some residual catalyst present in the polymer and/or to improve degassing of the polymer. The hot steam has preferably a temperature greater than 90° C., preferably greater than or equal to 100° C., in any embodiment, the hot steam may be superheated steam, for example at a temperature greater than or equal to 100° C. or greater than or equal to 110° C. The hot steam participates to the effect of maintaining the polymer at a second temperature (T₂) of (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁).

In one embodiment or preferably, the system further comprises a dryer inserted between and fluidically connected to the first process vessel and the second process vessel, and comprising an outlet for evacuating residual moisture.

In order to recover a dry and purged polymer, the steaming system is not connected to the second process vessel.

Preferably, the system further comprises a first recovery line connected the first exhaust gas outlet of the first process vessel and connected to
a waste vessel; or
a burner; or
the reactor; or
a separation system configured to separate the purge gas and/or the steam introduced to the first process vessel from the undesirable compounds and:
to recover the undesirable compounds separated from the purge gas and/or the steam to the polymerization reactor;
to recover the steam to the steaming system; and/or
to recover the purge gas to the second purge gas system.

Preferably, the system comprises a moisture recovering line connected to the steaming system.

Preferably, the system further comprises a second recovery line connected to the second exhaust gas outlet of the second process vessel and connected to
a waste vessel; or
a burner; or
the reactor; or
a separation system configured to separate the purge gas introduced to the second process vessel from the undesirable compounds and to:
recover the undesirable compounds separated from the purge gas and/or the steam to the polymerization reactor; and/or
to recover the purge gas to the purge gas system.

Preferably, one separation system can be a separation apparatus such as the one described in the document WO2018204026 in the name of the Applicant and hereby incorporated by reference, or any other known gas separation system known in the art. In some embodiments, the system may comprise at least one temperature monitoring device (not shown) and at least one additional heating device (not shown) arranged in at least one of the first transfer line, the first process vessel, the second transfer line, the second process vessel and the purge gas delivery piping system, the at least one temperature monitoring device being in communication with a temperature controller (not shown) and, the at least one additional heating device being operated by the temperature controller to provide heating in case of at least one of the temperature monitoring device measures at a second temperature (T₂) such that T₂ is (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁).

The present system is adapted for the production and purge of any kind of polymers such as but not limited to homopolymers, copolymers, polyolefins, polyethylene, polypropylene, polystyrenes, polyesters, polyurethane, polysiloxanes, polyacrylates, impact copolymers, etc.

In some other embodiments, the polymerization reactor may be a stirred tank reactor, a loop reactor, a fluidized bed reactor, a tubular reactor, a tower reactor or an extruder reactor or a combination thereof. It is preferred that the polymerization reactor system be a gas phase polymerization reactor system including preferably a fluidized bed reactor. In a preferred embodiment of the disclosure, the system is adapted for production of any kind of polymers obtainable with a gas phase reactor, or fluidized bed reactor.

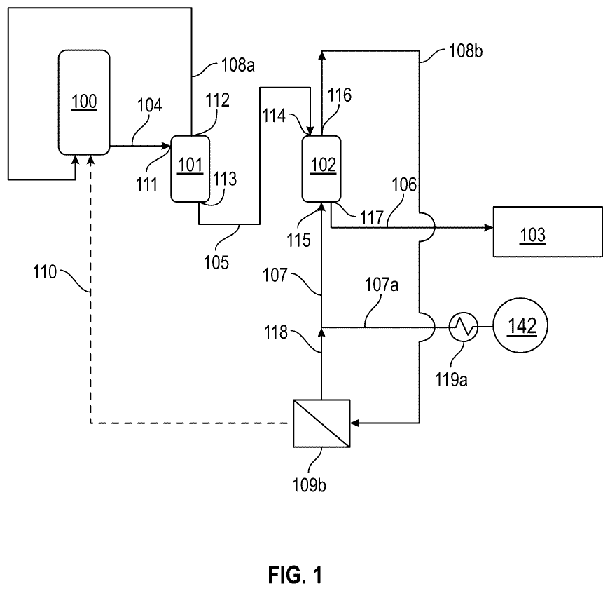

A first embodiment of the system according to the present disclosure is schematized in FIG. 1. The system comprises a polymerization reactor 100, a first process vessel 101, a second process vessel 102, a purged polymer recovery section 103, a first purge gas system comprising a purge gas source 142 and a purge gas feeding line 107, fluidically connected to the second process vessel 102. The system may further comprise a gas recovery system comprising a first recovery line 108a fluidically connected to the first process vessel 101 for recovering at least some of the undesirable compounds. After purification and separation, at least one of the VOCs and/or the residual polymerization reactants and purge gas can be flowed back to the reactor. Optionally, a separation or purification apparatus can be inserted in the recovery line 108a. One suitable separation apparatus can be for example one described in the document WO2018204026 in the name of the Applicant and hereby incorporated by reference, or any other known gas separation system known in the art. The polymerization reactor 100 is fluidically connected to the first process vessel 101 by a first transfer line 104 to withdraw the polymer from the polymerization reactor and discharging the polymer to the first process vessel 101 through a first polymer inlet 111 of the process vessel. The first process vessel comprises a first exhaust gas outlet 112 which may be connected to the first recovery line 108a for evacuating the undesirable compounds which are allowed to be evaporated in the first process vessel 101. The first process vessel 101 further comprises a first polymer outlet 113 connected to a second transfer line 105 for transferring the polymer from the first process vessel 101 to the second process vessel 102 through a second polymer inlet 114 of the second process vessel 102. The second process vessel 102 comprises a purge gas inlet 115 preferably arranged opposite to the second polymer inlet 114 and connected to the purge gas feeding line 107 for introducing purge gas from the purge gas source 142 in the second process vessel 102. The second process vessel 102 further comprises a second exhaust gas outlet 116 preferably fluidically connected to a second recovery line 108b for recovering the undesirable compounds and the purge gas. The second process vessel 102 further comprises a second polymer outlet 117 opposite to the second polymer inlet 114, and connected to a third transfer line 106 for transferring the polymer purged from VOCs and/or residual polymerization reactants thereby obtained to the purged polymer recovery section 103. Preferably, the second recovery line 108b is connected to a gas separating system 109b, such as for example one described in the document WO2018204026 in the name of the Applicant and hereby incorporated by reference, or any other known gas separation system known in the art. The gas separating system 109b is preferably configured for separating the purge gas from the undesirable compounds and comprises a first portion configured for collecting the purge gas and fluidically connected to the purge gas feeding line 107 through a purge gas recycling line 118 for recycling the purge gas and second portion configured for collecting the undesirable compounds and preferably fluidically connected to the reactor 100 through an undesirable compounds recycling line 110. Advantageously, the gas separation system 109b or the undesirable compounds recycling line 110 may comprise an additional separation and purification device (not shown) for recovering purified monomers that can be reused in the reactor 100. Alternatively, the undesirable compounds and optionally the purge gas may be transferred to a waste bin (not shown) or to a burner (not shown). Preferably, in order to maintain the polymer at a second temperature (T₂) while the polymer is flowing from the polymerization reactor to the second process vessel, at least one of the first transfer line 104, the first process vessel 101, the second transfer line 105, and the second process vessel 102 are insulated, where T₂ is (a) and/or (b) where (a) is T₁−20° C.≤T₂≤T₁ (or T₁−15° C.≤T₂≤T₁, or T₁−10° C.≤T₂≤T₁, or T₁−5° C.≤T₂≤T₁) and (b) is 70° C.≤T₂≤T₁ (or 80° C.≤T₂≤T₁, or 90° C.≤T₂≤T₁). Preferably, the system further comprises a heater 119a arranged on the purge gas feeding line 107a upstream the second process vessel 102 for heating the purge gas.

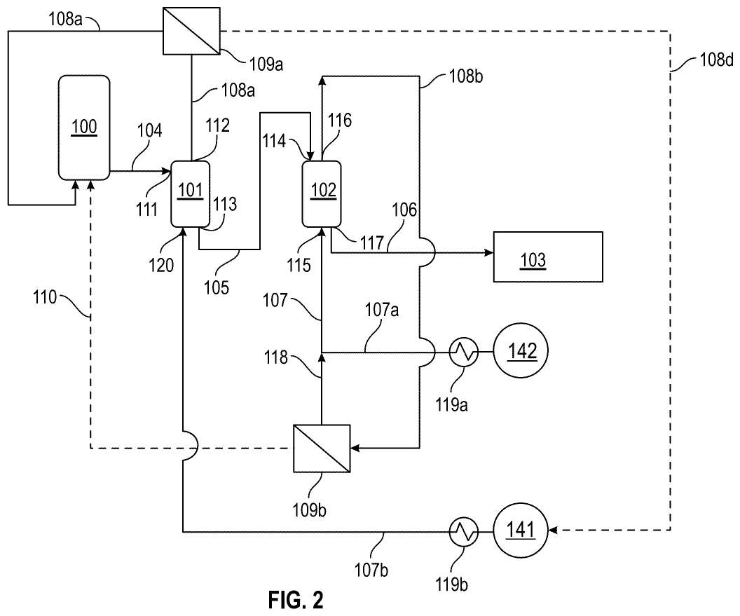

A second embodiment of the system according to the present disclosure is schematized in FIG. 2. The system comprises the same elements as described for the first embodiment of the system and further comprises a second purge gas system comprising a purge gas source 141 and a second purge gas feeding line 107b. The first process vessel 101 further comprises a purge gas inlet 120 preferably arranged opposite to the first polymer inlet 111 and connected to the purge gas feeding line 107b for introducing purge gas in the first process vessel 101. The first exhaust gas outlet 112 of the first purge vessel 101 is preferably connected to a first recovery line 108a for evacuating the undesirable compounds and the purge gas. The undesirable compounds can be separated and purified and some recovered monomers can be reused in the reactor. The first recovery line 108a can be fluidically connected to the reactor 100 and a separation or purification device 109a can be inserted in the recovery line 108a. A first portion of the first recovery line 108a can be used for recovering the undesirable compounds and a second recycling line 108d fluidically connected to the separation or purification device and to the purge gas source 141 can be used for recovering the purge gas to be reused into the purge gas source 141. Advantageously, the gas separation system 109a or the first recovery line 108a may comprise an additional separation and purification device (not shown) for recovering purified monomers that can be reused in the reactor 100.

Preferably, the system further comprises a heater 119b arranged on the purge gas feeding line 107b upstream of the first process vessel 101.

Preferably, the purge gas source 142 supplying the second purge vessel 102 is a source of nitrogen or any other inert gas whereas the purge gas source 141 supplying the first process vessel 101 is a source of hydrocarbon gas.

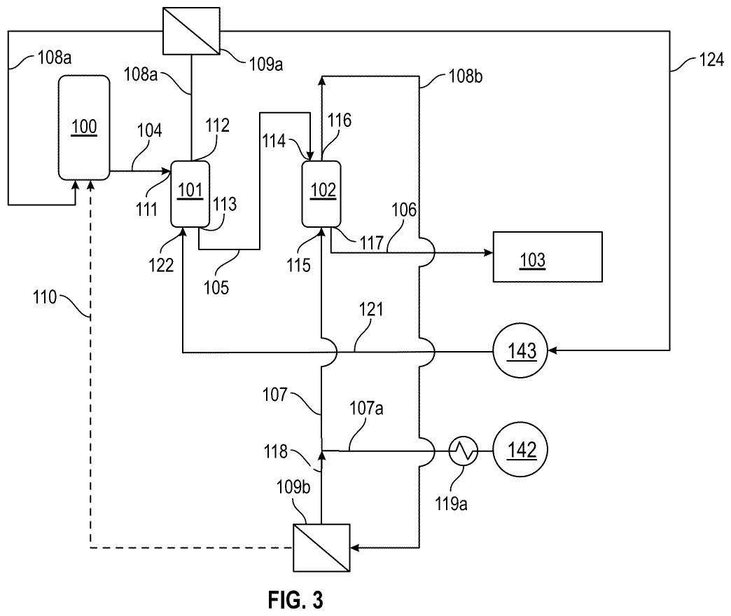

A third embodiment of the system according to the present disclosure is schematized in FIG. 3. The system comprises the same elements as described for the first embodiment of the system and further comprises a steaming system comprising a steam source or steam generator 143 and a steam feeding line 121 fluidically connected to the first process vessel 101. The gas recovery system comprises a recovery line 108a fluidically connected to the first process vessel 101 for recovering the undesirable compounds and the steam. The first process vessel 101 comprises a steam inlet 122 preferably arranged opposite to the first polymer inlet 111 and connected to the steam feeding line 121. The first process vessel 101 comprises a first exhaust gas outlet 112 preferably connected to the recovery line 108a for evacuating the undesirable compounds and the steam. Preferably, a gas separating system 109a is inserted in the recovery line 108a and is configured for separating moisture from the undesirable compounds. The gas separating system 109a comprises a first portion configured for collecting the moisture and fluidically connected to the steaming system 143 through a recovery line 124, and a second portion configured for collecting the undesirable compounds and fluidically connected to the reactor 100 through an undesirable compounds recovery line 108a. Advantageously, the gas separation system 109a or the first recovery line 108a may comprise an additional separation and purification device (not shown) for recovering purified monomers that can be reused in the reactor 100. Alternatively, the undesirable compounds and optionally the moisture may be transferred to a waste bin (not shown) or to a burner (not shown). In this embodiment, the injection of hot steam in the first process vessel 101 participates to maintain the polymer at the desired level of temperature.

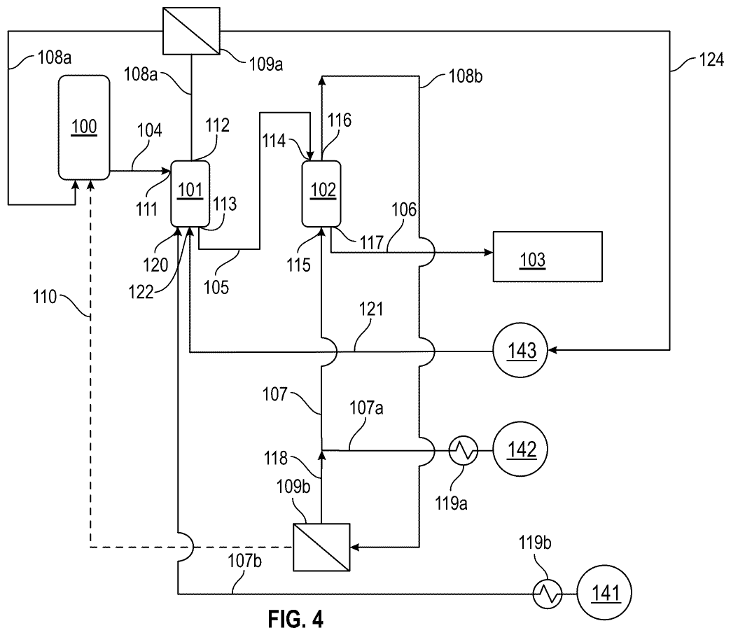

A fourth embodiment of the system according to the present disclosure is schematized in FIG. 4. The system of the fourth embodiment differs from the third embodiment of FIG. 3, in that it further comprises a second purge gas system comprising a purge gas source 141 and a second purge gas line 107b. The first process vessel 101 further comprises a purge gas inlet 120 in addition to the steam inlet 122 both arranged opposite to the first polymer inlet 111. The purge gas inlet 120 is fluidically connected to the second purge gas line 107b for introducing purge gas in the first process vessel 101. The injection of purge gas though the purge inlet 120 and the injection of hot steam through the steam inlet 122 can be performed simultaneously or sequentially.

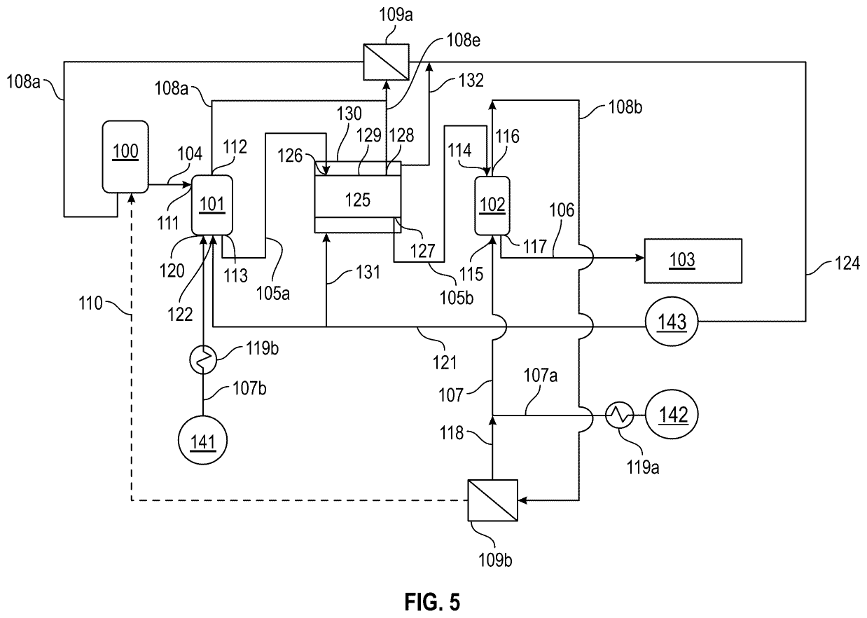

A fifth embodiment of the system according to the present disclosure is schematized in FIG. 5. The system of the fifth embodiment comprises the same elements described for the system according to the fourth embodiment of FIG. 4 and further comprises a dryer 125 inserted between the first process vessel 101 and the second process vessel 102. The dryer 125 preferably comprises an inner cylinder 129 comprising a dryer polymer inlet 126 for receiving the polymer, a dryer polymer outlet 127 and a dryer exhaust gas outlet 128. The dryer is preferably arranged with the axis of the inner cylinder substantially horizontal and preferably comprises a motorized shaft (not shown) arranged parallel or coaxial to the axis of the inner cylinder and comprising blades configured for agitating the polymer and pushing the polymer towards the dryer polymer outlet 127. The inner cylinder 129 is preferably surrounded by a cylindrical jacket 130 for heating the polymer inside the inner cylinder 125. The heat of the cylindrical jacket 130 may be provided by steam coming from an auxiliary line 131 extending from the steam feeding line 121 and the steam flowing through the cylindrical jacket 130 is evacuated through a steam recovering line 132 fluidically connected to the steam generator 143. Alternatively, hot steam provided to the cylindrical jacket 130 may come from another source of hot steam. A transfer line 105a extends from the first outlet 113 of the first process vessel 101 to the dryer polymer inlet 126 arranged in the inner cylinder 129 and a transfer line 105b extends from the dryer polymer outlet 127 to the second polymer inlet 114 of the second process vessel 102. The inner cylinder 129 of the dryer 125 further comprises an exhaust gas outlet 128 preferably connected to the recovery line 108e for evacuating the moisture from the polymer. Recovery line 108e may be fluidically connected to recovery line 108a as shown in FIG. 5. Alternatively, recovery line 108e may enter separation system 109a separately from recovery line 108a. Alternatively, the dryer 125 may be heated by electrical resistance, heat exchanger or any other means or device known by the skilled person.

Other embodiments of the system according to the present disclosure may include further process vessels inserted between the first process vessel and the second process vessel.

In a third aspect, the disclosure relates to a purged polymer obtainable by the process described hereinabove, preferably using a system as described hereinabove. The purged polymer can be obtained from any kind of polymers manufactured in the polymerization reactor, such as but not limited to homopolymers, copolymers, polyolefins, polyethylene, polypropylene, polystyrenes, polyesters, polyurethane, polysiloxanes, polyacrylates, impact copolymers, etc.

An advantage of the disclosure described herein is that the process requires less external sources of heat to drive devolatilization of polymers. The preferred method of introducing heat is via a gas-phase reactor (GPR) when in service, in order to utilize the polymerization heat of reaction, rather than external heat sources. The reaction temperature is allowed to rise to the maximum of the catalyst capability and/or the tackiness limit of the polymer to prevent plugging and fouling, whichever is lower. The reaction temperature may be in the range of 70° C. to 110° C., with a preferred range of 90° C. to 100° C. The latent heat of the polymer achieved in this manner is then maintained throughout the following steps with a combination of heated purge gas media and high insulation capacity of downstream vessels and piping. Alternatively, this heat can be introduced through a number of mechanical heating processes where steam, fired, or electrical heating mediums are used to heat the polymer in a vessel, either upstream of or within a purge vessel utilized in the purge process. Without being bounded by any theory, the prevention of cooling of the polymer in the process allows the maximization of diffusion rates of the volatile and/or odorous molecules while contacting the polymer with the purge gas.

In another embodiment of the present disclosure, the process for producing a polymer, in particular a purged polymer, comprises the steps of:
i) manufacturing a polymer in a polymerization reactor in the presence of a catalyst;
ii) discharging the polymer from the polymerization reactor into a first process vessel;
iii) at least partially removing undesirable compounds including volatile organic compounds and/or residual polymerization reactants from the polymer and/or odorous compounds, and optionally contacting the polymer with a flow of purge gas in the first process vessel;
iv) transferring the polymer from the first process vessel to a second process vessel;
v) contacting the polymer in the second process vessel with a flow of purge gas; and
vi) recovering a polymer from which undesirable compounds have been purged
wherein the step iii) comprises flowing the polymer in a plug-flow fashion into the first process vessel and feeding superheated steam in a countercurrent fashion to the polymer.

The latter embodiment of the process may be operated using the third, the fourth or the fifth embodiment of the system as mentioned above, with or without an insulated portion of the system.

### ADDITIONAL EMBODIMENTS

Embodiment 1. A process for producing a polymer, in particular a purged polymer, comprising the steps of: i) manufacturing a polymer in a polymerization reactor in the presence of a catalyst at a first temperature (T₁), wherein the catalyst has a maximum catalyst capability dependent on temperature, and wherein the polymer has a tackiness limit dependent on temperature; ii) discharging the polymer from the polymerization reactor into a first process vessel; iii) at least partially removing undesirable compounds including volatile organic compounds and/or residual polymerization reactants from the polymer and/or odorous compounds, and optionally contacting the polymer with a flow of a first purge gas in the first process vessel; iv) transferring the polymer from the first process vessel to a second process vessel; v) contacting the polymer in the second process vessel with a flow of a second purge gas; and vi) recovering a polymer product comprising the polymer from which undesirable compounds have been purged; wherein the first temperature is allowed to rise to the maximum of the catalyst capability and/or the tackiness limit of the polymer to prevent plugging and fouling; and wherein the steps ii) to v) are operated while maintaining the polymer at a second temperature (T₂) such that T₁−20° C.≤T₂≤T₁ and/or 70° C.≤T₂≤T₁, wherein the T₂ for the step ii) may be different than the T₂ for the step v).

Embodiment 2. The process according to Embodiment 1, wherein the flow of the first purge gas and the flow of the second purge gas originate from the same source.

Embodiment 3. The process according to Embodiments 1-2, wherein the polymer is maintained at temperature T₂ by: providing thermal insulation to at least one location between the polymerization reactor and the second process vessel; and/or injecting hot steam or superheated steam into the first process vessel; and/or heating the first purge gas and/or the second purge gas.

Embodiment 4. The process according to Embodiments 1-3 wherein step iii) is performed by: allowing evaporation of at least some of the undesirable compounds from the polymer in the first process vessel and evacuating from the first process vessel the at least some of the undesirable compounds; or contacting the polymer with steam or superheated steam in the first process vessel and evacuating from the first process vessel the steam charged with at least some of the undesirable compounds; or contacting the polymer with the flow of the first purge gas in the first process vessel and evacuating from the first process vessel the first purge gas charged with at least some of the undesirable compounds; or contacting the polymer with the flow of the first purge gas and steam in the first process vessel and evacuating from the first process vessel a mixed stream charged with at least some of the undesirable compounds.

Embodiment 5. The process of any one of Embodiments 1˜4 wherein step iii) is performed in the presence of steam or superheated steam and is followed by a further step of drying prior to step v).

Embodiment 6. The process of any one of Embodiments 1-5 wherein step v) is performed in the absence of steam.

Embodiment 7. A system for producing a purged polymer comprising: a polymerization reactor suitable for being operated at a first temperature and for producing a polymer; a first process vessel configured for at least partially removing undesirable compounds including volatile organic compounds and/or residual polymerization reactants and/or odorous compounds from the polymer, the first process vessel comprising a first polymer inlet (111) fluidically connected to the polymerization reactor (100) for receiving the polymer, a first polymer outlet (113) for discharging the polymer with a reduced content of undesirable compounds, a first exhaust gas outlet (112) for evacuating at least some of the undesirable compounds, and optionally a first purge gas inlet (120) for introducing a first purge gas; a second process vessel (102) configured for purging the polymer with a reduced content of undesirable compounds, comprising a second polymer inlet (114) fluidically connected to the first process vessel (101) for receiving the polymer with a reduced content of undesirable compounds, a second polymer outlet (117) for discharging the polymer purged from undesirable compounds, a second purge gas inlet (115) for introducing a second purge gas and a second exhaust gas outlet (116) for discharging the second purge gas charged with undesirable compounds purged from the polymer; a purge gas system (142, 107) configured to introduce the second purge gas in the second process vessel (102); a purged polymer recovery section (103) fluidically connected to the second process vessel (102); wherein the system is configured for maintaining the polymer at a second temperature (T₂) while the polymer is flowing from the polymerization reactor to the second process vessel, such that T₁−20° C.≤T₂≤T₁ and/or 70° C.≤T₂≤T₁.

Embodiment 8. The system according to Embodiment 7, wherein the first purge gas and the second purge gas originate from the same source.

Embodiment 9. The system according to Embodiments 7-8, wherein the purge gas system is a second purge gas system, and wherein the system further comprises a first purge gas system configured to introduce a first purge gas in the first process vessel.

Embodiment 10. The system according to Embodiments 7-9 comprising at least one of the following: an insulated portion of the system arranged to at least one location between the polymerization reactor (100) and the second process vessel (102), and/or; a heater (119) or a heat exchanger (50) configured for heating the first purge gas and/or the second purge gas.

Embodiment 11. The system according to any one of Embodiments 7 to 10 further comprising a steaming system (143, 121) configured to introduce hot steam or superheated steam in the first process vessel (101).

Embodiment 12. The system according to any one of Embodiments 7 to 11, further comprising a dryer (125) inserted between and fluidically connected to the first process vessel (101) and the second process vessel (102), and comprising a dryer exhaust gas outlet (128) for evacuating residual moisture.

Embodiment 13. The system according to Embodiments 7-12, further comprising a first recovery line (108a) connected the first exhaust gas outlet (112) of the first process vessel (101) and connected to a waste vessel; or a burner; or the reactor (100); or a separation system (109a) configured to separate the first purge gas and/or the steam introduced to the first process vessel from the undesirable compounds and: to recover the undesirable compounds separated from the first purge gas and/or the steam to the polymerization reactor (100); to recover the steam to the steaming system (143, 121); and/or to recover the first purge gas to the purge gas system (141, 123).

Embodiment 14. The system according to Embodiments 7-13, further comprising a second recovery line (108b) connected to the second exhaust gas outlet (116) of the second process vessel (102) and connected to a waste vessel; or a burner; or the reactor (100); or a separation system (109b) configured to separate the second purge gas introduced to the second process vessel from the undesirable compounds and to: recover the undesirable compounds separated from the second purge gas and/or the steam to the polymerization reactor (100); and/or to recover the second purge gas to the second purge gas system.

Embodiment 15. The system according to Embodiment 14, wherein the at least one temperature monitoring device and at least one additional heating device are additionally arranged in at least one location on a first purge gas feeding line and/or a second purge gas feeding line.

Embodiment 16. The system according to any one of Embodiments 7 to 15 further comprising at least one temperature monitoring device and at least one additional heating device arranged in at least one location between the polymerization reactor and the second process vessel, the at least one temperature monitoring device being in communication with a temperature controller and, the at least one additional heating device being operated by the temperature controller to provide heating to maintain T₂.

Embodiment 17. The system according to any one of Embodiments 7 to 13 wherein the polymerization reactor (100) is a gas-phase reactor and comprises a recovery line (40) for recovering heated unreacted monomers, the recovery line being in contact with at least one heat exchanger (50) to remove the heat of unreacted monomers.

Embodiment 18. A purged polymer obtainable by the process of Embodiments 1 to 6, having an odor characteristic measured according to the method VDA270 from not perceptible to clearly perceptible but not disturbing.

Embodiment 19. A process for producing a polymer, in particular a purged polymer, comprising the steps of: i) manufacturing a polymer in a polymerization reactor in the presence of a catalyst; ii) discharging the polymer from the polymerization reactor into a first process vessel; iii) at least partially removing undesirable compounds including volatile organic compounds and/or residual polymerization reactants from the polymer and/or odorous compounds, and optionally contacting the polymer with a flow of a first purge gas in the first process vessel; iv) transferring the polymer from the first process vessel to a second process vessel; v) contacting the polymer in the second process vessel with a flow of a first purge gas; and vi) recovering a polymer from which undesirable compounds have been purged; wherein the step iii) comprises flowing the polymer in a plug-flow fashion into the first process vessel and feeding superheated steam in a countercurrent fashion to the polymer.

To facilitate a better understanding of the embodiments of the present disclosure, the following examples of preferred or representative embodiments are given. In no way should the following examples be read to limit, or to define, the scope of the disclosure.

### EXAMPLES

Comparative impact copolymers have been prepared from a gas phase polymerization process in a gas phase polymerization reactor under standard conditions of temperature in the reactor at 85° C. well under the catalyst limit of capability and/or the tackiness limit of the polymer to prevent plugging and fouling. The impact copolymers thereby obtained were purged under nitrogen flow under standard conditions.

Comparative samples of impact copolymers produced in the conditions above have been tested for determination of odor characteristics according to the method VDA270 published by the Automobile Industry Association VDA (Verband der Automobileindustrie). The method is based on odor evaluation scale of prepared samples tested by at least three individual testers. The odor evaluation scales comprise six grades:
Grade 1: not perceptible;
Grade 2: perceptible, not disturbing;
Grade 3: clearly perceptible but not disturbing;
Grade 4: disturbing;
Grade 5: strongly disturbing; and
Grade 6: not acceptable.

The grade assessed for the odor of comparative impact copolymers after purging in standard conditions was 4.1, i.e. the odor was disturbing.

A total volatile organic contaminant (TVOC) measurement according to the VDA277 method has been performed to the comparative sample and the average TVOC content was 113 ppm.

Other comparative impact copolymer samples were prepared and purged by varying the conditions of purge gas flow of steam flow but none of these purge conditions provided a purged impact copolymer having a TVOC measured according to VDA277 method lower than 99 ppm.

An impact copolymer according to the disclosure has been prepared from a gas phase polymerization process in a gas phase polymerization reactor but the temperature of the reactor was increased to 90° C. (i.e., closer to the catalyst capability limit and the tackiness limit of the polymer to prevent plugging and fouling). The impact copolymers thereby obtained were purged under nitrogen flow under standard conditions. The increase of temperature in the reactor provided an impact copolymer according to the disclosure with a reduced odor grade of 3.6, thereby in between clearly perceptible but not disturbing and disturbing, and a TVOC content measured according to the VDA277 method of 87 ppm, i.e. a decrease of 23% of TVOC only when the reactor temperature is increased by 5° C. and the purging conditions are unchanged.

One or more illustrative embodiments incorporating the disclosure embodiments disclosed herein are presented herein. Not all features of a physical implementation are described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present disclosures. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular examples and configurations disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1.-18. (canceled)

19. A process for producing a polymer, in particular a purged polymer, comprising the steps of:
i) manufacturing a polymer in a polymerization reactor in the presence of a catalyst at a first temperature (T1), wherein the catalyst has a maximum catalyst capability dependent on temperature, and wherein the polymer has a tackiness limit dependent on temperature;
ii) discharging the polymer from the polymerization reactor into a first process vessel;
iii) at least partially removing undesirable compounds including volatile organic compounds and/or residual polymerization reactants from the polymer and/or odorous compounds, and optionally contacting the polymer with a flow of a first purge gas in the first process vessel;
iv) transferring the polymer from the first process vessel to a second process vessel;
v) contacting the polymer in the second process vessel with a flow of a second purge gas; and
vi) recovering a polymer product comprising the polymer from which undesirable compounds have been purged;
wherein the first temperature is allowed to rise to the maximum of the catalyst capability and/or the tackiness limit of the polymer to prevent plugging and fouling; and
wherein the steps ii) to v) are operated while maintaining the polymer at a second temperature (T2) such that T1−20° C.≤T2≤T1 and/or 70° C.≤T2≤T1, wherein the T2 for the step ii) may be different than the T2 for the step v).

20. The process of claim 19, wherein the polymer is maintained at temperature T2 by:
providing thermal insulation to at least one location between the polymerization reactor and the second process vessel; and/or
injecting hot steam or superheated steam into the first process vessel; and/or
heating the first purge gas and/or the second purge gas.

21. The process of claim 19 wherein step iii) is performed by:
allowing evaporation of at least some of the undesirable compounds from the polymer in the first process vessel and evacuating from the first process vessel the at least some of the undesirable compounds; or
contacting the polymer with steam or superheated steam in the first process vessel and evacuating from the first process vessel the steam charged with at least some of the undesirable compounds; or
contacting the polymer with the flow of the first purge gas in the first process vessel and evacuating from the first process vessel the first purge gas charged with at least some of the undesirable compounds; or
contacting the polymer with the flow of the first purge gas and steam in the first process vessel and evacuating from the first process vessel a mixed stream charged with at least some of the undesirable compounds.

22. The process of claim 19, wherein step iii) is performed in the presence of steam or superheated steam and is followed by a further step of drying prior to step v).

23. The process of claim 19 wherein step v) is performed in the absence of steam.

24. A system for producing a purged polymer comprising:
a polymerization reactor suitable for being operated at a first temperature (T1) and for producing a polymer;
a first process vessel configured for at least partially removing undesirable compounds including volatile organic compounds and/or residual polymerization reactants and/or odorous compounds from the polymer, the first process vessel comprising a first polymer inlet fluidically connected to the polymerization reactor for receiving the polymer, a first polymer outlet for discharging the polymer with a reduced content of undesirable compounds, a first exhaust gas outlet for evacuating at least some of the undesirable compounds, and optionally a first purge gas inlet for introducing a first purge gas;
a second process vessel configured for purging the polymer with a reduced content of undesirable compounds, comprising a second polymer inlet fluidically connected to the first process vessel for receiving the polymer with a reduced content of undesirable compounds, a second polymer outlet for discharging a polymer product comprising the polymer from which undesirable compounds have been purged, a second purge gas inlet for introducing a second purge gas and a second exhaust gas outlet for discharging the second purge gas charged with undesirable compounds purged from the polymer;
a purge gas system configured to introduce the second purge gas in the second process vessel;
a purged polymer recovery section fluidically connected to the second process vessel;
wherein the system is configured for maintaining the polymer at a second temperature (T2) while the polymer is flowing from the polymerization reactor to the second process vessel, such that T1−20° C.≤T2≤T1 and/or 70° C.≤T2≤T1.

25. The system according to claim 24, wherein the purge gas system is a second purge gas system, and wherein the system further comprises a first purge gas system configured to introduce a first purge gas in the first process vessel.

26. The system according to claim 24, comprising at least one of the following:
an insulated portion of the system arranged to at least one location between the polymerization reactor and the second process vessel; and/or
a heater or a heat exchanger configured for heating the first purge gas and/or the second purge gas.

27. The system according to claim 24, further comprising a steaming system configured to introduce hot steam or superheated steam in the first process vessel.

28. The system according to claim 24, further comprising a dryer inserted between and fluidically connected to the first process vessel and the second process vessel, and comprising a dryer exhaust gas outlet for evacuating residual moisture.

29. The system according to claim 24, further comprising a first recovery line connected the first exhaust gas outlet of the first process vessel and connected to at least one of:
a waste vessel; or
a burner; or
the reactor; or
a separation system configured to separate the first purge gas and/or the steam introduced to the first process vessel from the undesirable compounds and:
to recover the undesirable compounds separated from the first purge gas and/or the steam to the polymerization reactor;
to recover the steam to the steaming system; and/or
to recover the first purge gas to the first purge gas system.

30. The system according to claim 24, further comprising a second recovery line connected to the second exhaust gas outlet of the second process vessel and connected to
a waste vessel; or
a burner; or
the reactor; or
a separation system configured to separate the second purge gas introduced to the second process vessel from the undesirable compounds and to:
recover the undesirable compounds separated from the second purge gas and/or the steam to the polymerization reactor; and/or
to recover the second purge gas to the second purge gas system.

31. The system of claim 24, further comprising at least one temperature monitoring device and at least one additional heating device arranged in at least one location between the polymerization reactor and the second process vessel, the at least one temperature monitoring device being in communication with a temperature controller and, the at least one additional heating device being operated by the temperature controller to provide heating to maintain T2.

32. The system of claim 31, wherein the at least one temperature monitoring device and at least one additional heating device are additionally arranged in at least one location on a first purge gas feeding line and/or a second purge gas feeding line.

33. The system of claim 24, wherein the polymerization reactor is a gas-phase reactor and comprises a recovery line for recovering heated unreacted monomers, the recovery line being in contact with at least one heat exchanger to remove the heat of unreacted monomers.

34. A purged polymer obtainable by the process of claim 19, having an odor characteristic measured according to the method VDA270 from not perceptible to clearly perceptible but not disturbing.

35. A process for producing a polymer, in particular a purged polymer, comprising the steps of:
i) manufacturing a polymer in a polymerization reactor in the presence of a catalyst;
ii) discharging the polymer from the polymerization reactor into a first process vessel;
iii) at least partially removing undesirable compounds including volatile organic compounds and/or residual polymerization reactants from the polymer and/or odorous compounds, and optionally contacting the polymer with a flow of a first purge gas in the first process vessel;
iv) transferring the polymer from the first process vessel to a second process vessel;
v) contacting the polymer in the second process vessel with a flow of a second purge gas; and
vi) recovering a polymer product comprising the polymer from which undesirable compounds have been purged;
wherein the step ill) comprises flowing the polymer in a plug-flow fashion into the first process vessel and feeding superheated steam in a countercurrent fashion to the polymer.
